(19) United States
(12) Patent Application Publication
(10) Pub. No.: US 2017/0178474 A1
(43) Pub. Date: Jun. 22, 2017

(54) PRODUCT-MONITORING DRONE

(71) Applicant: Checkpoint Systems, Inc., Thorofare, NJ (US)

(72) Inventors: Daniel James Olson, Voorhees, NJ (US); Eugene Joseph Horgos, Wilmington, DE (US); George West, Aston, PA (US); Richard A. Howe, II, Mantua, NJ (US)

(21) Appl. No.: 15/041,334

(22) Filed: Feb. 11, 2016

Related U.S. Application Data
(60) Provisional application No. 62/269,608, filed on Dec. 18, 2015.

(51) Int. Cl. G08B 13/196; G08B 13/24; B64C 39/02; H04N 7/18

(52) U.S. Cl. CPC G08B 13/1965; H04N 7/183; G08B 13/2462; B64C 39/024; B64C 2201/127

(57) ABSTRACT

In one embodiment, the invention can be a system for monitoring a product, system including a transponder configured to attach to a product in a store; a drone comprising a camera, the drone configured to wirelessly communicate with the transponder; follow the transponder to maintain the wireless communication with the transponder; utilizing the camera, take a photograph or a video of the product to which the transponder is attached; and transmit a wireless alert signal upon an indication of an excessive separation between the drone and the transponder; and an employee device having a user interface, the user interface configured to display an alert when the drone sends the wireless alert signal.

### CROSS REFERENCE TO RELATED APPLICATIONS

The present application claims the benefit of U.S. Provisional Patent Application No. 62/269,608 filed on Dec. 18, 2015, which is incorporated herein by reference in its entirety.

### BACKGROUND

Retail theft is an ongoing concern for retail stores. Existing security systems such as Electronic Article Surveillance (EAS) systems have provided significant benefit, but shoplifting remains an issue. It is also a challenge for retail stores to gain accurate information on the browsing habits of their customers. Accurate browsing information can allow retail stores to alter their layout to encourage more purchases and enhance the shopping experience. Thus, there is need for a system and method that helps further prevent retail theft, and/or can gather information regarding the browsing habits of customers.

### BRIEF SUMMARY

The present disclosure can be directed to a method, system, and/or apparatus for monitoring a product. In one aspect, a system for monitoring a product includes a transponder configured to attach to a product in a store; a drone comprising a camera, the drone configured to wirelessly communicate with the transponder; follow the transponder to maintain the wireless communication with the transponder; utilizing the camera, take a photograph or a video of the product to which the transponder is attached; and transmit a wireless alert signal upon an indication of an excessive separation between the drone and the transponder; and an employee device having a user interface, the user interface configured to display an alert when the drone sends the wireless alert signal.

In another aspect, an apparatus includes an antenna configured to facilitate wireless communication with a transponder attached to a product in a store; a maneuvering device configured to cause the apparatus to follow the transponder and move the apparatus with the transponder to maintain the wireless communication with the transponder; and a camera configured to take a photograph or a video of the product to which the transponder is attached; wherein the antenna is further configured to transmit a wireless alert signal upon an indication of an excessive separation between the drone and the transponder.

In yet another aspect, a method for monitoring a product from a store includes associating a transponder with a drone; attaching the transponder to a product in a store; initiating wireless communication between the drone and the transponder; hovering the drone above the transponder and moving the drone with the transponder to maintain the wireless communication between the drone and the transponder; taking, from the drone, a photograph or a video of the product to which the transponder is attached; transmitting a wireless alert signal upon an indication of an excessive separation between the drone and the transponder; and in response to the wireless alert signal, displaying an alert at a user interface of an employee device.

In yet another aspect, a system for monitoring a product includes a transponder configured to attach to a product in a store; a drone comprising a camera, the drone configured to wirelessly communicate with the transponder; hover above and move with the transponder to maintain the wireless communication with the transponder; utilizing the camera, take a photograph or a video of the product to which the transponder is attached; and transmit a wireless alert signal upon an indication that the drone is outside a predetermined area; and an employee device having a user interface, the user interface configured to display an alert when the drone sends the wireless alert signal.

### BRIEF DESCRIPTION OF THE DRAWINGS

The present disclosure will become more fully understood from the detailed description and the accompanying drawings, wherein:

FIG. 1 is a diagram of a system according to one embodiment.

FIG. 2 is a block diagram of a drone according to one embodiment.

FIG. 3 is a block diagram of a transponder according to one embodiment.

FIG. 4 is a top view of a store where a transponder and drone become excessively separated according to one embodiment.

FIG. 5 is a user interface of an employee device showing a first alert according to one embodiment.

FIG. 6 is a top view of a store where a transponder moves outside a predetermined area according to one embodiment.

FIG. 7 is a user interface of an employee device showing a second alert according to one embodiment.

FIG. 8 is a user interface of an employee device showing a third alert according to one embodiment.

FIG. 9 is a method of monitoring a product according to one embodiment.

FIG. 10 is a top view of a store where shopping trends are determined according to one embodiment.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. The discussion herein describes and illustrates some possible non-limiting combinations of features that may exist alone or in other combinations of features. Furthermore, as used herein, the term or is to be interpreted as a logical operator that results in true whenever one or more of its operands are true.

Features of the present invention may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

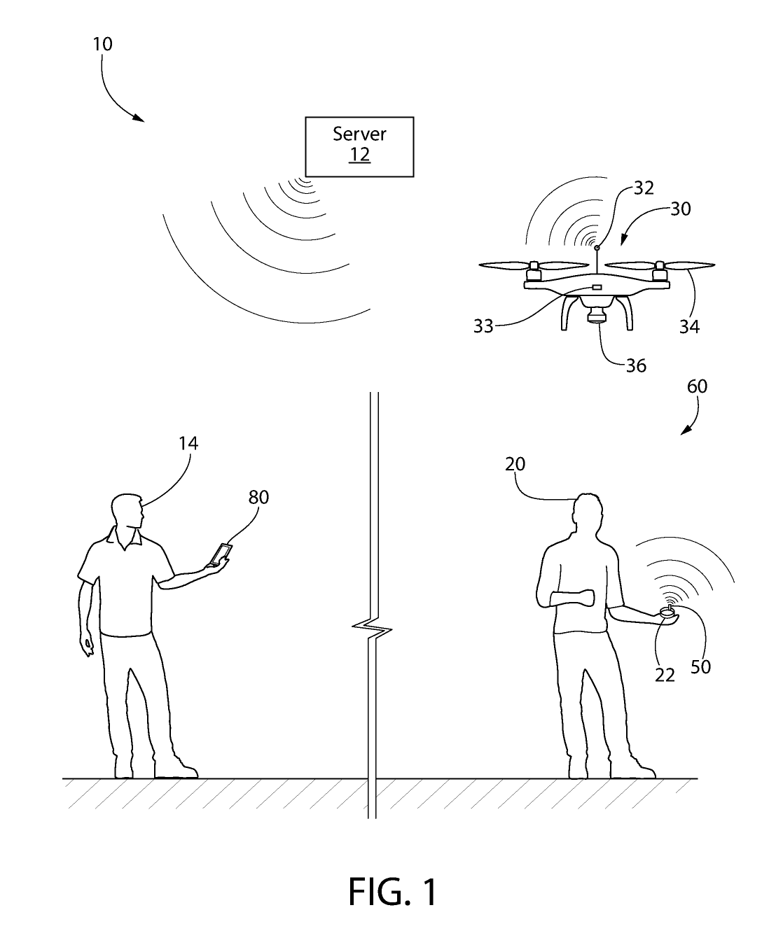

Referring now to FIG. 1, a system 10 according to one embodiment is shown. The system 10 can include a drone 30, a transponder 50, a server 12, and an employee device 80 in a store 60. The system 10 can be used to follow and monitor the transponder 50 when it is attached to a product 22 in the store 60. The store 60 can be an type of building or room where items are sold.

In the exemplified embodiment, a transponder 50 is attached to a product 22 (e.g., a bracelet). A person 20 is carrying the product 22 in the store 60. The transponder 50 can be configured to be in wireless communication with the drone 30 to enable the drone 30 to follow the transponder 50. The transponder 50 can be any device for attaching to a product and sending a wireless signal to the drone 30. Attachment to the product 22 can include any type of fastening, joining, or connecting (permanent or non-permanent) that can keep the transponder 50 physically close to the product 22 as the product 22 is moved. In the exemplified embodiment, the transponder 50 can also receive signals from the drone 30 and can sound an alarm under certain circumstances (e.g., circumstances indicating a theft or a risk of theft). The product 22 can be any item sold or displayed in a store. The product 22 can be moved by being carried, or transported in a cart, or by another means.

The drone 30 includes a flight device 34 for enabling the drone 30 to fly. In the exemplified embodiment, the flight device 34 is a propeller device comprising a set of propellers and accompanying electronics for enabling the drone 30 to hover above and move with the transponder 50. In other embodiments, the drone 30 can be any device configured to enable the drone 30 to hover above and move with the transponder 50. One of skill in the art will appreciate that while many example embodiments described herein are provided with the context of a drone that is maneuverable via flight, it is contemplated that the described techniques and embodiments would also be applicable to a drone that is maneuverable on the ground, floor, ceilings, etc., via, for example, wheels or tracks. As a result, the flight device 34 may be generically considered a maneuvering device in some example embodiments.

The drone 30 of the exemplified embodiment further includes a camera 36. The camera 36 can be configured to take photographs and/or video of a transponder 50, the product to which the transponder 50 is attached, the area surrounding the transponder, and/or the person or thing moving the transponder 50. Further, as discussed below, the camera 36 can be programmed to take and store photographs or videos under particular circumstances or when certain criteria are detected by the drone, and can communicate such photographs and videos to other devices. Further, photographs and/or videos can be taken at regular intervals to provide a timeline of events. The camera 36 can have features similar to that of a camera that mounts on a drone so that the camera can follow a signal from a transponder.

The drone 30 of the exemplified embodiment can further include a light 33. This light 33 can serve as an indicator. For example, it can indicate an alarm event, or that the drone 30 has been turned on, or that the camera 36 is in operation. In other embodiments, the light 33 can serve other purposes, such as illuminating an area to be photographed or video recorded.

The drone 30 of the exemplified embodiment can further include an antenna 32. The antenna 32 can be configured to send and receive signals to communicate with devices, including enabling wireless communication between the drone 30 and the transponder 50. For example, the antenna 32 can be configured to receive a wireless communication signal from the transponder 50. Further, the antenna 32 can be configured to transmit a wireless alert signal upon an indication of an excessive separation between the drone 30 and the transponder 50 (e.g., when the communication signal from the transponder 50 has a signal strength at or below a predetermined value, or when the drone 30 determines that a distance between the drone 30 and the transponder 50 is greater than a predetermined distance). An excessive separation between the drone 30 and transponder 50 can be distinguished from a standard separation that occurs when the drone 30 is hovering above and following the transponder 50. In the exemplified embodiment, the antenna 32 is configured to transmit a wireless alert signal to the server 12.

The server 12 can be any device having a processor for executing computer programs and receiving and communicating data directly or indirectly. In the exemplified embodiment, the server 12 can operate with a router (not shown) or other communication device to send and receive signals. The wireless alert signal can be sent in a variety of situations, including when a theft is suspected or underway, when a valuable item has left a designated area, when the drone 30 and transponder 50 have been separated by a certain distance, and/or when communication between the drone 30 and transponder 50 has been weakened or lost. In the exemplified embodiment, the wireless alert signal is sent when there is indication of an excessive separation between the drone 30 and the transponder 50. The wireless alert signal can be any wireless signal indicating that an event or condition warranting an alert has occurred.

The server 12 can be further configured to send data (or to instruct another device to send data) to a device 80 of an employee 14. In this embodiment, when the alert signal from the drone 30 is received by the server 12, the server 12 can send a signal to the device 80, causing the device to show an alert. By so doing, the store employee can receive immediate information regarding a potential issue in the store 60 and take action to address the issue, such as following a potential thief. The different types of alerts and alarms that can occur will be discussed in more detail below. In the exemplified embodiment, the employee device 50 is a smartphone. In other embodiments, the device 80 can be any device configured to receive and provide notice of an alert, including a visual or audible indication of an alert. The employee 14 can be any person employed by or otherwise working for the store, including those working to promote security (such as a security office or a contractor).

In other embodiments, an alert signal can be configured to be sent directly to the employee device 80, causing the device 80 to display an alert. In yet other embodiments, the alert signal can be received by another device for causing the employee device 80 (directly or indirectly) to display an alert.

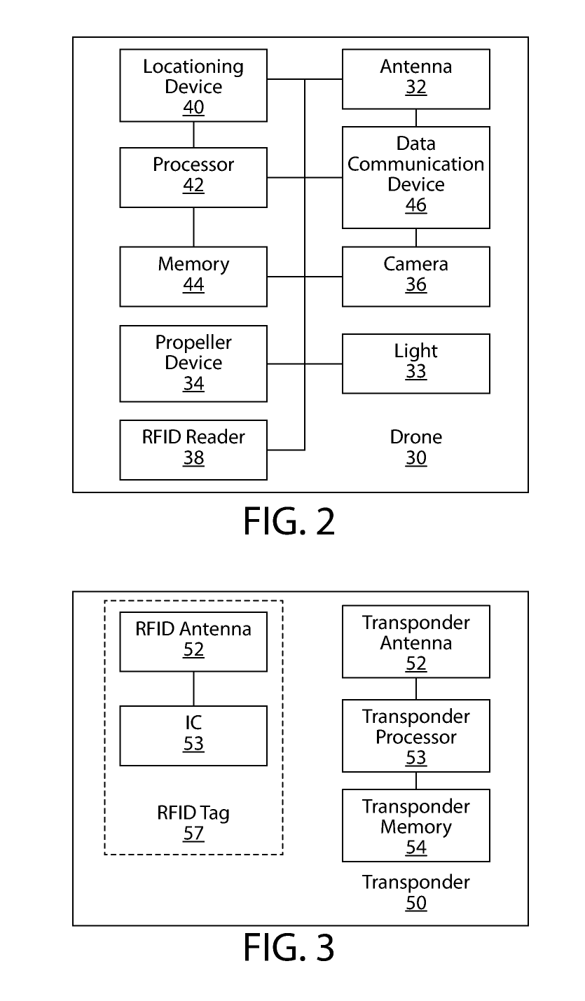

FIG. 2 is a block diagram of a drone 30 according to one embodiment. As discussed above, the drone 30 can include a camera 36, a flight device 34, a light 33, and an antenna 32. The drone 30 can further include a processor 42. The processor 42 can be in communication with the other components of the drone 30 to help control their operation. For example, the processor 42 can instruct the antenna 32 to send the wireless alert signal or another signal, and can receive data from the antenna 32, such as data related to the changing location of the transponder 50. The processor 42 can also retrieve data from memory 44. The processor 42 can also instruct the camera 36 to take a photograph or video, and can receive data related to photographs and video taken. The processor 42 can also instruct the light 33 when to turn on or off. The processor 42 can also instruct the flight device how to operate given the changing location of the transponder 50.

The drone 30 can further include an RFID reader 38. The RFID reader 38 can be configured to receive signals from RFID tags and thereby determine an identifier associated with the RFID tag, such as an Electronic Product Code (EPC number). The reader 38 can be configured to send interrogation signals using antenna 32 or a separate antenna. The reader 38 can be coupled to the memory 44 for storing received identification information, and with the processor 42 to process the received identification information. In other embodiments, the drone 30 can use other technologies for reading identifiers associated with items or can omit a technology for reading identifiers associated with items.

The drone 30 can further include a locationing device 40. The locationing device 40 can be coupled to the processor 42 and antenna 32 and can use any technology for determining or estimating a location of the drone 30, such as Global Positioning System (GPS), multilateration, and methods utilizing angle of arrival, received signal strength and/or reference tags. In other embodiments, a locationing device can be omitted.

The drone 30 can further include a data communication device 46. Such a device 46 can be coupled to the processor 42 and can be configured to send and receive data using a data communication technology, such as mobile communications technology (e.g., 3G or 4G cellular data communication technologies) or local area wireless computer networking technology (e.g., Wi-Fi). Using such a technology, the drone 30 can send data (such as photographs or videos taken by the camera 36, item identification information, or location information) to another device. Such a technology can also be used to send instructions to the drone. The data communication device 46 can also be configured to contact law enforcement (and can include data such as photographs or videos taken, or a location of the drone 30). In other embodiments, a data communication device can be omitted.

FIG. 3 is a block diagram of a transponder 50 according to one embodiment. The transponder 50 can include a transponder processor 53 and a transponder memory 54. The transponder processor 53 can be coupled to a transponder antenna 52 and can instruct the transponder antenna 52 to send a transponder signal. The transponder antenna 52 can be further configured to receive signals from other devices, such as drone 30, and provide data to the transponder processor 53 associated with the received signals.

In the exemplified embodiment, the transponder 50 further includes a passive RFID tag 57. The RFID tag 57 includes an RFID antenna 58 and an integrated circuit (IC) 58. The passive RFID tag 57 is configured to receive an interrogation signal and send in response a modulated backscatter signal to the RFID reader 38. In other embodiments, the transponder processor 53 and the RFID processor can share use of a single antenna. In other embodiments, RFID tag 57 can be any type of REID tag, including tags utilizing semi-passive or active technologies, or can utilize another type of identification technology. In yet embodiments, the RFID tag and its components can be omitted.

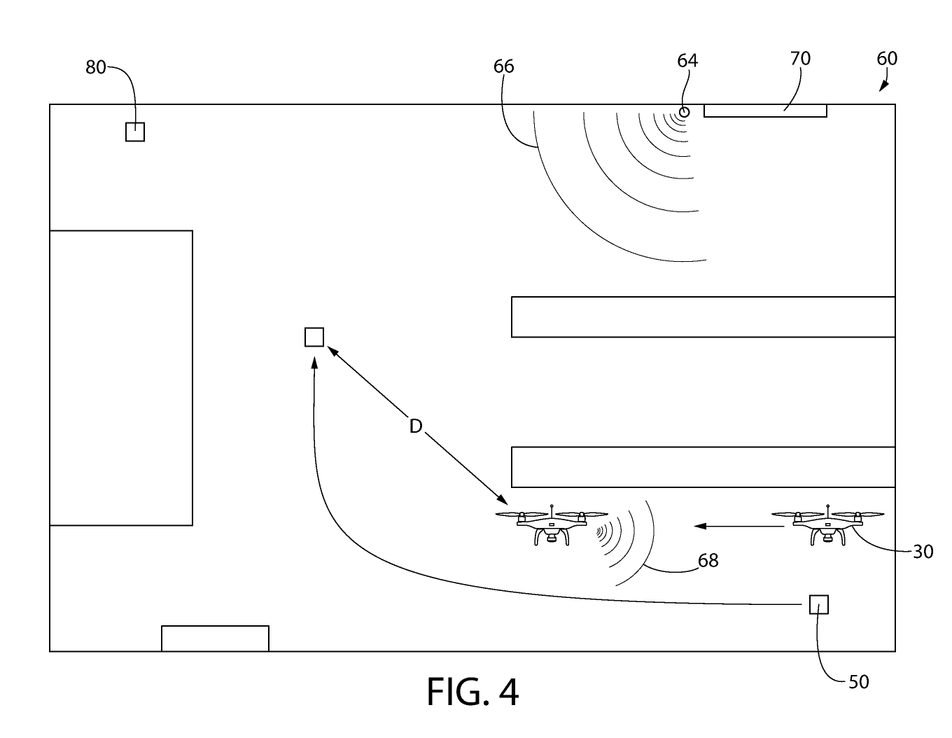

FIG. 4 is a top view of a store 60 where a transponder 50 and drone 30 become excessively separated according to one embodiment. In a first position, the transponder 50 is attached to a product (not shown) and the drone 30 hovers above or otherwise closely follows, such as in the case of a non-flying drone. As the transponder 50 and product move toward the center of the store 60, however, the drone 30 is not able to follow, and is excessively separated from the transponder 50 by a distance D. The inability of the drone 30 to follow the transponder 50 could be due to several causes, such as the transponder 50 getting stuck or being tampered with (e.g., the flight device being disrupted, the drone being physically blocked from proceeding in a desired direction, or the antenna being damaged), the transponder 50 losing battery power, the transponder 50 being damaged, or the transponder 50 being shielded (e.g., by body shielding) such that the transponder 50 is unable to send and/or receive signals.

When the transponder 50 and drone 30 become excessively separated, the drone 30 can send a wireless alert signal, which causes the store employee device 50 to display an alert. Further, the drone 30 can be configured to sound a local alarm 68, such as an audible and/or visual alarm on the drone 10 (including use of light 33 shown in FIG. 1). Further, the excessive separation can cause a system alarm 66, such as that emitted by a security gate 64 at an entrance/exit 70 of the store 60.

There are several methods by which excessive separation between the drone 30 and transponder 50 can be detected. In one embodiment, the transponder 50 is configured to transmit a wireless communication signal, and the drone 30 hovers above (or closely follows) and moves with the transponder 50 to maintain receipt of the wireless communication signal from the transponder 50. Excessive separation is detected when it is determined that the wireless communication signal from the transponder 50 has a signal strength at or below a predetermined value. In other embodiments, excessive separation can be detected by the drone 30 or system determining that a distance D between the drone 30 and the transponder 50 is greater than a predetermined distance, the distance D being determined using a locationing technology such as GPS, multilateration, or methods utilizing angle of arrival, received signal strength and/or reference tags.

Before, during, and/or after the excessive separation, the camera 36 can take a photograph or a video of the transponder 50 and of the product to which the transponder 50 is attached. Such photographs and/or video are also likely to include images of the person carrying the product (a potential shoplifter). If the person is a shoplifter, these photographs or video can be used to identify the shoplifter. They can also be used to determine the item stolen, tactics used in carrying out the theft, and accomplices. The camera 36 can be triggered by the transponder 50 going into motion, the drone 30 going into motion, the drone 30 or transponder 50 exiting a predetermined area, excessive separation between the drone 30 and transponder 50, or another circumstance. In one embodiment, while the alert occurs when the signal strength of the wireless communication signal is at or below a first predetermined value, the photo or video is taken (or begins to be taken) when the signal strength of the wireless communication signal is at or below a second predetermined value. The second predetermined value can be a value where the signal strength is starting to weaken, and the first predetermined value can be a value where the signal strength has further weakened such that it is lost or almost lost.

Photographs or video taken (along with a location of the drone 30) can be stored on the drone 30, and/or can be sent to store personnel or to law enforcement. A data communication device (such as data communication device 46 in FIG. 2) can be used to contact store personnel or to law enforcement, including providing notification that a theft is currently underway. A locationing device (such as locationing device 40 of FIG. 2) can be used to determine the drone's location.

Photographs and video can also help determine the tactics used by shoplifter, such as whether they used cutting tools or magnets. This information can be used to prevent future shoplifting events.

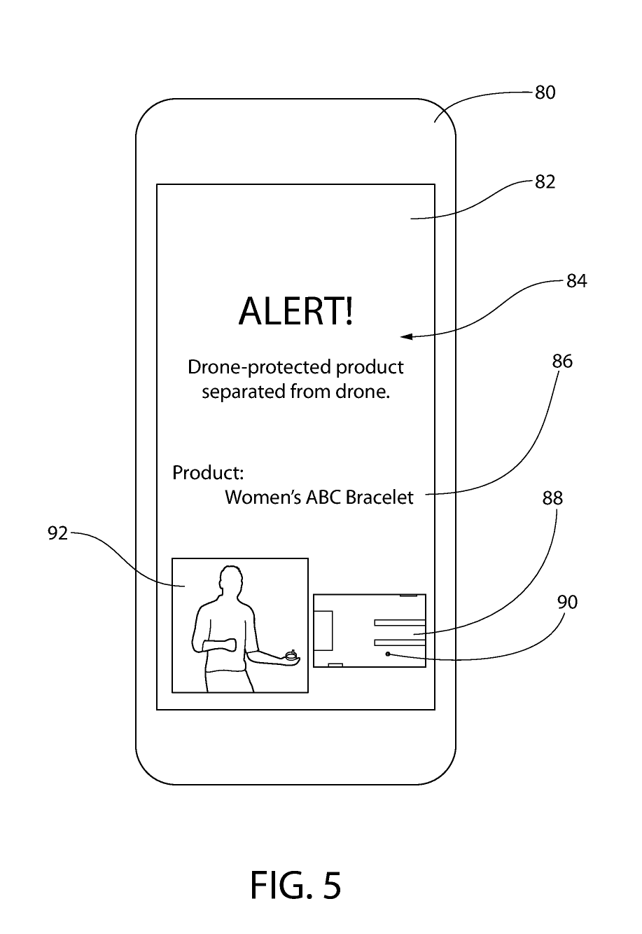

FIG. 5 is a user interface 82 of an employee device 80 showing a first alert 84 according to one embodiment In the exemplified embodiment, the employee device 80 is a smartphone and the user interface 82 is a smartphone touchscreen. In other embodiments, the employee device 80 can be any be any device configured to receive and provide notice of an alert, the user interface 82 can be any interface for displaying the alert on the employee device 80, and the alert can be any notice (e.g., visual or audio) provided in response to the wireless alert signal. In this embodiment, the first alert 84 indicates that the product has become excessively separated from the drone 30. It further provides a product identifier 86—in this example, a description of the product determined by reading an RFID tag associated with the product. The alert 84 further comprises a photograph 92 (taken by the drone 30) of the product and potential shoplifter, and a map 88 of the store indicating the drone location 90. The drone location can be determined by a locationing device (such as locationing device 40 of FIG. 2) and the photograph 92 can be taken by the camera 36 (see FIG. 2). This information can help an employee to track down the person carrying the drone-protected product through the store and determine whether a shoplifting even is occurring.

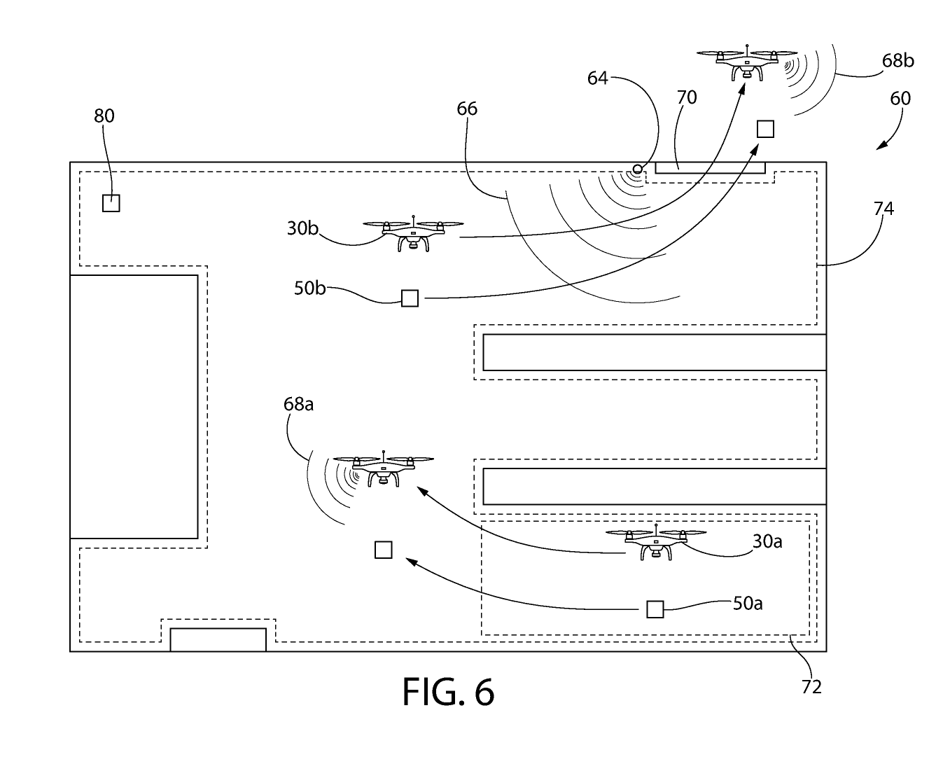

FIG. 6 is a top view of a store 60 where a transponder 50a, 50b on a product (not shown) moves outside a predetermined area 72, 74 according to one embodiment. Two transponders 50a, 50b and drones 60a, 60b are shown. The first transponder 50a and drone 30a begin in a first predetermined area 72. A person then moves the first transponder 50a outside the first predetermined area 72. The first drone 30a travels with the first transponder 50a. When the first drone 30a determines that it 30a is outside the first predetermined area 72, a local drone alarm 68a is sounded. A system alarm 66 at security gate 64 of the entrance/exit 70 can also be activated. A transponder alarm can also be activated. In one example, the first transponder 50a is attached to a bracelet, and the first predetermined area 72 is the jewelry department. If a person trying on the bracelet takes the bracelet outside the jewelry department, the drone alarm 68a can be activated. Further, an alert can be provided to an employee device to notify the employee to check on the drone-protected product.

The second transponder 50b begins in a second predetermined area 74, the second predetermined area 74 representing the entire sales floor. A person then moves the second transponder 50b outside the second predetermined area 74 in an attempt to steal the product (not shown) to which the second transponder 50b is attached. The second drone 30b travels with the second transponder 50b. When the second drone 30b determines that it is outside the second predetermined area 74, a local drone alarm 68a is sounded. A system alarm 66 at security gate 64 of the entrance/exit 70 can also be activated. A transponder alarm can also be activated, and an alert can be provided to an employee device. Further, the drone 30b can follow the transponder 50b outside the store 60 and to a parking lot, and can take photographs or video of the shoplifter's car, license plate, accomplices, and/or direction of travel to help law enforcement apprehend the shoplifter.

In another embodiment, a store may offer products that can be tested outside before purchase. Such products could include golf clubs, bicycles, skates, and fishing equipment. The drone 30b could be used to follow the shopper outside the store to keep track of the location of the product to which the transponder 50b is attached.

It is further noted that a store could use multiple drones and/or multiple transponders. For example, a drone could be configured to take over for a first drone when the first drone loses battery power or communication with the transponder. In another example, a drone could be associated with multiple transponders attached to multiple products, the drone configured to follow the moving product of highest value.

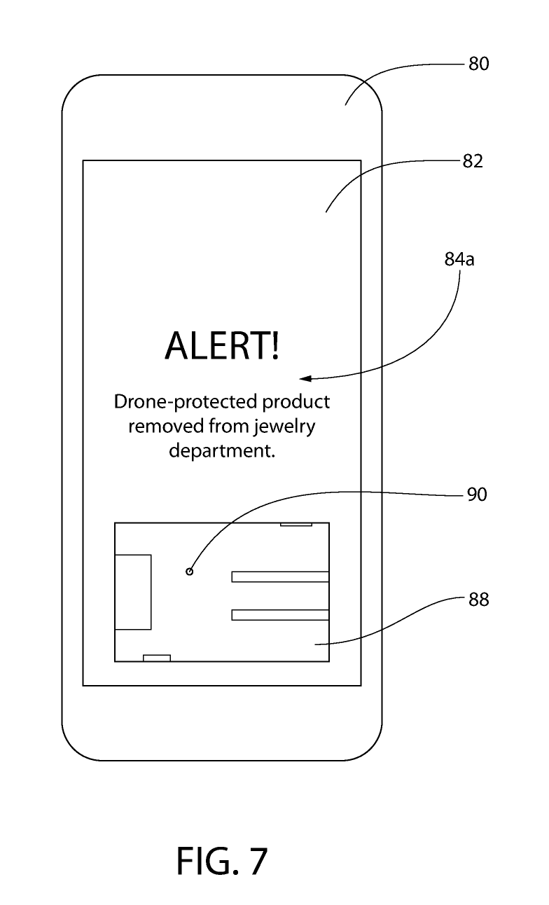

FIG. 7 is a user interface 82 of an employee device 80 showing a second alert 84a according to one embodiment. Similar to FIG. 5, in the exemplified embodiment, the employee device 80 is a smartphone and the user interface 82 is a smartphone touchscreen. In this embodiment, the second alert 84a indicates that the product has been removed from a first predetermined area (as with transponder 50a in FIG. 6). It further provides a map 88 of the store indicating the drone location 90. In this embodiment, the drone can still be moving with the product, and therefore the map 88 can show a live drone location 90, which updates as the drone moves. The drone location can be determined by a locationing device (such as locationing device 40 of FIG. 2). This information can help an employee to track down the person carrying the drone-protected product through the store and determine whether a shoplifting even is occurring.

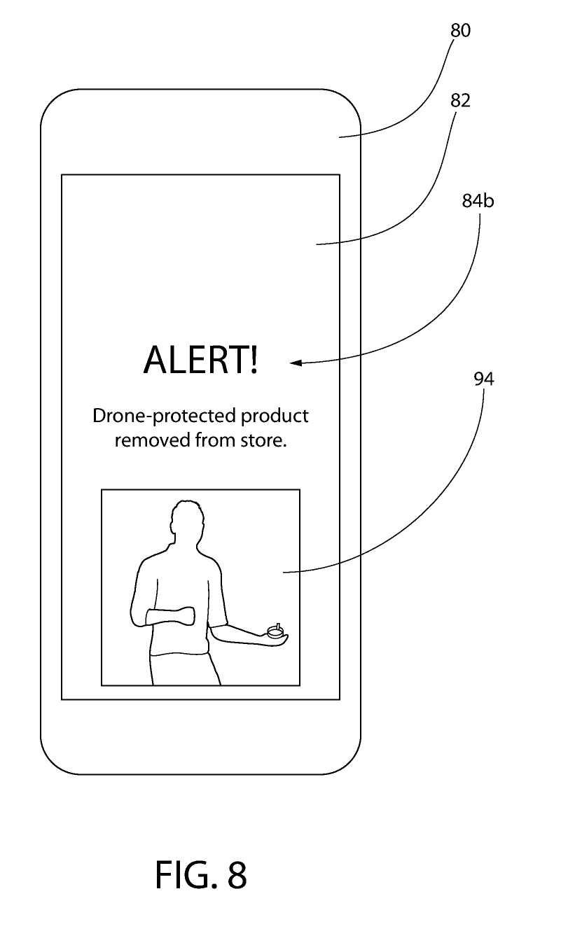

FIG. 8 is a user interface 82 of an employee device 80 showing a third alert 84b according to one embodiment. Similar to FIGS. 5 and 7, in the exemplified embodiment, the employee device 80 is a smartphone and the user interface 82 is a smartphone touchscreen. In this embodiment, the third alert 84b indicates that the product has been removed from the store (as with transponder 50b in FIG. 6). It further provides a live video 94 taken by the camera of the transponder, product, and/or potential shoplifter. This information can help an employee to track down the person caning the drone-protected product outside the store.

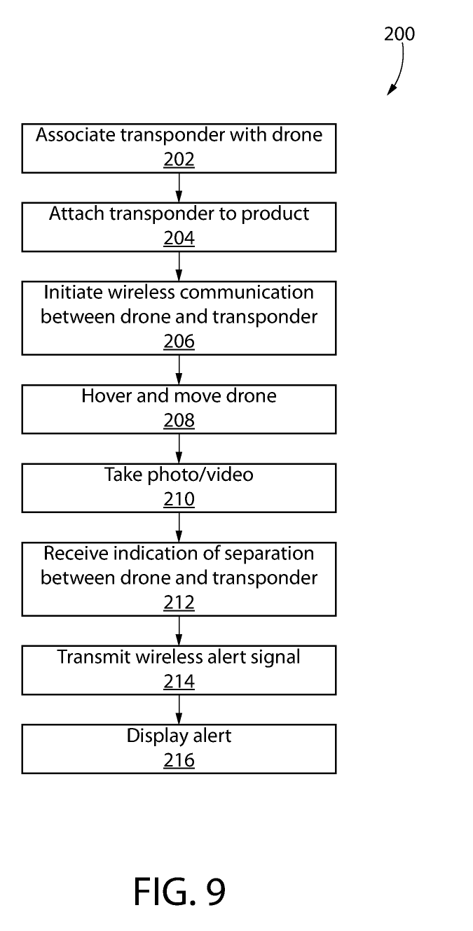

FIG. 9 shows a method 200 of monitoring a product according to one embodiment. The exemplified method 200 associates a transponder with a drone (operation 202). This association can instruct the drone to follow the transponder. Further, the transponder is attached to a product in a store (operation 204). Further, wireless communication is initiated between the drone and the transponder (operation 206). Further, the drone can hover above or otherwise closely follow the transponder and move with the transponder to maintain the wireless communication between the drone and the transponder (operation 208). In one embodiment, the transponder moves to maintain receipt of the wireless communication signal from the transponder and thereby remain above the transponder. In other embodiments, the transponder can use other means to remain above the transponder.

The exemplified method 200 further includes the drone taking a photo or a video of the product to which the transponder is attached (operation 210). Further, there can be indication of an excessive separation between the drone and transponder (operation 212). In response, a wireless alert signal can be sent (operation 214). As discussed above, this wireless alert signal can be sent by the drone and to a server or to another device. When the wireless alert signal is sent, an alert can be displayed at a user interface of an employee device (operation 216). As indicated above, the method 200 can include various other features and/or alternatives. Further, the operations discussed above need not occur in the order shown.

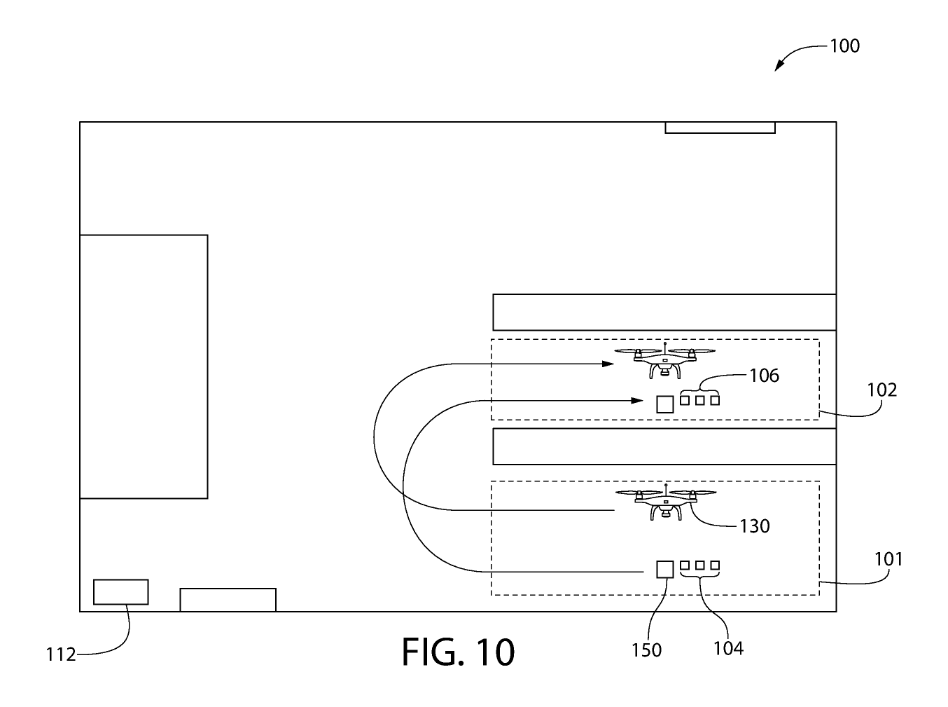

FIG. 10 is a top view of a store 100 where shopping trends are being observed according to one embodiment. In this embodiment, the drone 130 includes an RFID reader (not shown). The drone 130 begins in a first department 101 (e.g., the jewelry department). The drone 130 is following transponder 150, which is attached to a product (e.g., a bracelet (not shown)). The reader of the drone 130 can read an RFID tag associated with the product, as well as a first plurality of RFID tags 104 associated with other first department products.

The person carrying the product to which the transponder 150 is attached walks to a second department 102 (e.g., women's blouses). The drone 130 follows. The drone 130 can continue to read RFID tags. When the drone 130 enters the second department 102, the drone 130 reads a second plurality of RFID tags 106 associated with second department products.

With the data obtained by the drone 130, certain patterns of shopping trends can be determined. For example, it can be determined that people in the jewelry department regularly visit the women's shoes department immediately thereafter. Based on this data, a store can alter its floor layout to increase purchases and enhance convenience for shoppers.

In the exemplified embodiment, a local server 112 receives data from the drone 130 (including RFID data, time data, and related data), and the local server 112 is configured to receive the data and determine the shopping trends based on the received data. Further, the drone 130 does not begin reading tags until the transponder 150 has paused for a predetermined amount of time. In other embodiments, other identification technology can be used, other devices besides a local server can be used to determine shopping trends, and the drone 130 can read tags at any time.

Other features can be included. For example, the drone could be responsive to voice commands such that a person carrying a product being followed by a drone could ask the drone questions (e.g., “Where is the shoe department?”). In response, the drone could speak an answer and/or guide the person to an area of the store.

The drone could also have mobile checkout capabilities. For example, the drone could have RFID functionality such that it could read the items in a person's cart and check the person out without requiring the person to go to a checkout portion of the store to buy products.

The embodiments discussed above provide several advantages, some of which have already been discussed. The presence of a drone can cause deterrence. A potential shoplifter being followed by a drone will be less likely to carry out a theft. Further, as discussed above, the drone can obtain information about the shoplifting event (e.g., item stolen, tactics used in carrying out the theft, and accomplices) that can be helpful in apprehending the criminal. Further, the drone can bring detection beyond the retail store building, enabling the capture of information such as car identity, license plate, and direction of travel. Further, a drone can provide extra protection to items leaving a certain department, or can monitor items that must be tested outside the store. Some embodiments can also enable stores to learn more about shopping trends and thereby help a store alter its floor layout to increase purchases and enhance shopper experience.

While the various example embodiments have been described with respect to specific examples, those skilled in the art will appreciate that there are numerous variations and permutations of the above that may be implemented without departing from the scope of the present invention. Also, it is to be understood that other embodiments may be utilized and structural and functional modifications may be made without departing from the scope of the present invention. Thus, the spirit and scope should be construed broadly as set forth in the appended claims.

What is claimed is:

1. A system for monitoring a product, the system comprising:
a transponder configured to attach to a product in a store;
a drone comprising a camera, the drone configured to:
wirelessly communicate with the transponder;
follow the transponder to maintain the wireless communication with the transponder;
utilizing the camera, take a photograph or a video of the product to which the transponder is attached; and
transmit a wireless alert signal upon an indication of an excessive separation between the drone and the transponder; and
an employee device having a user interface, the user interface configured to display an alert when the drone sends the wireless alert signal.

2. The system of claim 1 wherein:
the drone is further configured to receiver wireless communication signal from the transponder; and
the indication of the excessive separation between the drone and the transponder comprises the wireless communication signal from the transponder having a signal strength at or below a predetermined value.

3. The system of claim 1 wherein the indication of the excessive separation between the drone and the transponder comprises the drone determining that a distance between the drone and the transponder is greater than a predetermined distance.

4. The system of claim 1 wherein the drone is configured to activate a local alarm (a) upon the indication of the excessive separation between the drone and the transponder, or (b) when the drone is outside a predetermined area.

5. The system of claim 1 wherein a system alarm is activated (a) upon the indication of the excessive separation between the drone and the transponder, or (b) when the drone is outside a predetermined area.

6. The system of claim 1 wherein:
the drone comprises a locationing device for determining a location of the drone; and
the user interface of the employee device is further configured to display an alert when the location of the drone is outside a predetermined area.

7. The system of claim 1 further comprising a server configured to:
receive the wireless alert signal from the drone; and
transmit a signal to the employee device instructing the user interface of the employee device to display the alert.

8. The system of claim 7 wherein the employee device'is a mobile device.

9. The system of claim 1 wherein the drone further comprises a data communication device configured to wirelessly transmit the photograph or the video taken by the camera.

10. The system of claim 9 wherein the data communication device uses cellular data communication.

11. The system of claim 9 wherein the data communication device is configured to contact law enforcement.

12. The system of claim 1 wherein the photograph or the video is taken when a location of the drone is outside a predetermined area.

13. The system of claim 1 wherein the photograph or the video is taken at regular time intervals.

14. The system of claim 1 wherein the alert displayed on the user interface of the employee device includes the photograph or video of the product or a person carrying the product.

15. The system of claim 1 wherein the alert displayed on the user interface of the employee device includes a map of the store showing a location of the drone.

16. The system of claim 1 wherein the alert displayed on the user interface of the employee device includes an identification of the product.

17. The system of claim 16 wherein:
the transponder comprises an RFID tag;
the drone comprises an RFID reader configured to communicate with the RFID tag of the transponder; and
the identification of the product is based on the communication of the drone with the RFID tag.

18. The system of claim 1 wherein:
the product forms part of a plurality of products;
each of the plurality of products has an RFID tag attached thereto to form a plurality of RFID tags;
the drone comprises an RFID reader configured to receive RFID data from the plurality of RFID tags; and
a server is configured to receive the RFID data from the drone and determine shopping trends based on the RFID data.

19. An apparatus comprising:
an antenna configured to facilitate wireless communication with a transponder attached to a product in a store;
a maneuvering device configured to cause the apparatus to follow the transponder and move the apparatus with the transponder to maintain the wireless communication with the transponder; and
a camera configured to take a photograph or a video of the product to which the transponder is attached;
wherein the antenna is further configured to transmit a wireless alert signal upon an indication of an excessive separation between the drone and the transponder.

20. A method for monitoring a product from a store, the method comprising:
associating a transponder with a drone;
attaching the transponder to a product in a store;
initiating wireless communication between the drone and the transponder;
hovering the drone above the transponder and moving the drone with the transponder to maintain the wireless communication between the drone and the transponder;
taking, from the drone, a photograph or a video of the product to which the transponder is attached;
transmitting a wireless alert signal upon an indication of an excessive separation between the drone and the transponder; and
in response to the wireless alert signal, displaying an alert at a user interface of an employee device.
